(19) United States
(12) Patent Application Publication
(10) Pub. No.: US 2008/0190156 A1
(43) Pub. Date: Aug. 14, 2008

(54) Enclosure Having an Escutcheon Plate with Extended Side Flanges, Fastening Clips and an Opposing Handle

(76) Inventors: David A. Nowicky, Fairport, NY (US); Kelvin H. Wildman, Honeoye Falls, NY (US)

Correspondence Address: JAECKLE FLEISCHMANN & MUGEL, LLP, 190 Linden Oaks, ROCHESTER, NY, 14625-2812, US

(21) Appl. No.: 10/585,557

(22) PCT Filed: Jan. 7, 2005
(86) PCT No.: PCT/US05/00438

§ 371 Date: Dec. 20, 2007

Related U.S. Application Data
(60) Provisional application No. 60/534,619, filed on Jan. 7, 2004.

(30) Foreign Application Priority Data
Apr. 23, 2004 (US) PCT/US2004/012555

(51) Int. Cl. E05B 15/02

(52) U.S. Cl. 70/452

(57) ABSTRACT

An escutcheon plate assembly including an escutcheon plate body, at least one flange, and a fastening clip is provided. The escutcheon plate body is positioned within an opening defined in a front panel of an enclosure. The flange includes a first portion that extends a first distance from the escutcheon plate body, and a second portion that extends a second distance from the escutcheon plate body. The first portion includes an extension wall and an offset wall that define a slot. The fastening clip is positioned within the slot between a back surface of the front panel and the first portion of the flange to securely fasten the escutcheon plate to the front panel. The escutcheon plate may also include a handle recess that operates in conjunction with a handle insert positioned on the opposite side of the enclosure to make it easier to pick up or move the enclosure.

### CROSS-REFERENCE TO RELATED APPLICATIONS

This application claims the benefit of U.S. Provisional Patent Application No. 60/534,619, filed on Jan. 7, 2004, and PCT Patent Application No. PCT/US2004/012555, filed on Apr. 23, 2004.

### STATEMENT REGARDING FEDERALLY SPONSORED RESEARCH OR DEVELOPMENT

Not applicable.

### BACKGROUND OF THE INVENTION

The present invention relates to an enclosure having an escutcheon plate, fastening clips and an opposing handle. More particularly, the present invention includes an escutcheon plate assembly including an escutcheon plate with extended side flanges that is fastened to a front panel of a stackable vertical file cabinet using a pair of fastening clips. Additionally, the escutcheon plate has a handle recess formed therein that may be used in conjunction with a handle recess insert positioned in the opposite side of the file cabinet to allow a person to pick up and move the file cabinet to a desired location.

Existing file cabinets may include an escutcheon plate mounted to the front panel of the cabinet drawer, which provides a location to mount a locking assembly and a handle to allow the drawer to be opened and closed. Existing escutcheon plates are positioned within an opening formed in the drawer and may be snapped to the drawer. When the escutcheon plate is snapped to the drawer, one portion of the escutcheon plate rests against the front surface of the drawer and another portion of the escutcheon plate rests against the rear surface of the drawer.

However, if there are manufacturing variances in the dimensions of the escutcheon plate, the escutcheon plate may not be securely positioned within the opening and may move relative to the drawer after the escutcheon plate is snapped into place. In addition, the portions of the escutcheon plate that rest against the front and rear surfaces of the drawer have a relatively small contact surface area. Therefore, the portions resting against the front and rear portions of the drawer are susceptible to breaking off of the main body of the escutcheon plate if too much force is used in opening the cabinet drawer or in moving the cabinet. Once the portions of the escutcheon plate that are resting against the front and rear portions of the drawer are broken, the escutcheon plate may become dislodged or otherwise removed from the cabinet.

Furthermore, these file cabinets are difficult to lift or move from one location to another. As discussed above, the escutcheon plate includes a single handle recess that allows a user to open or close the drawer or slide the cabinet across the floor. Sliding a cabinet across the floor may cause damage to either the cabinet or the floor. Therefore, if the cabinet is picked up to avoid damaging the cabinet and floor, a user would position one hand within the handle recess on the escutcheon plate and position the other hand underneath the cabinet. However, positioning a hand underneath the cabinet may be problematic if the cabinet is heavy or bulky. Moreover, in order to position a hand underneath the cabinet, the cabinet may have to be tipped on its corner, which could shift the position of the items contained within the cabinet causing one or more of the items to break.

Accordingly, there exists a need for an escutcheon plate that is securely fastened to an enclosure door. In addition, there is a need for making it easier to lift, carry or otherwise move an enclosure to a desired location. The present invention fills these needs as well as other needs.

### SUMMARY OF THE INVENTION

In order to overcome the above stated problems and limitations, there is provided an escutcheon plate assembly that operates to securely fasten an escutcheon plate to a drawer of a cabinet or enclosure. The escutcheon plate is attached to the enclosure so that the escutcheon plate will not easily break off, become dislodged or otherwise removed from the drawer when the escutcheon plate is used to open the drawer, pick up or move the cabinet.

In particular, the escutcheon plate assembly according to the present invention includes an escutcheon plate body, at least one flange, and a fastening clip. The escutcheon plate body is adapted to be positioned within the opening in a front panel on the drawer of the enclosure. The at least one flange includes first and second portions, wherein the first portion extends outwardly at a first distance from the escutcheon plate body, and wherein the second portion extends outwardly at a second distance from the escutcheon plate body. The first distance may be greater than the second distance. Further, the first portion includes an extension wall and an offset wall that define a slot. The fastening clip is adapted to be positioned within the slot between the front panel and the first portion of the at least one flange to secure the escutcheon plate to the front panel.

The present invention also provides a handle recess defined in the escutcheon plate that may be used in conjunction with a handle recess insert located on the opposite side of the enclosure to make it easier to lift or move the enclosure.

Additional objects, advantages and novel features of the present invention will be set forth in part in the description which follows, and will in part become apparent to those in the practice of the invention, when considered with the attached figures.

### BRIEF DESCRIPTION OF THE SEVERAL VIEWS OF THE DRAWINGS

The accompanying drawings form a part of the specification and are to be read in conjunction therewith, wherein like reference numerals are employed to indicate like parts in the various views, and wherein:

FIG. 1 is a front perspective view of a pair of stackable vertical filing cabinets, each having a file housing and an escutcheon plate assembly coupled with a front panel of a drawer using a pair of fastening clips according to the present invention;

FIG. 2 is an exploded view of one of the cabinets in FIG. 1 showing a cover shell, a rear shell, and a base that surround a blow-molded internal housing;

FIG. 3 is an enlarged partial top perspective view of the base showing a plurality of slots defined therein;

FIG. 4 is an enlarged front perspective view of the blow-molded internal housing shown in FIG. 2;

FIG. 5 is a side perspective view showing the escutcheon plate coupled with the front panel of the drawer;

FIG. 6 is a top perspective view of the front panel with the escutcheon plate assembly removed;

FIG. 7 is an enlarged partial front view of the escutcheon plate mounted to the front panel of the drawer;

FIG. 8 is a rear view of the escutcheon plate assembly shown in FIG. 7 showing the fastening clips positioned between the escutcheon plate and the front panel;

FIG. 9 is an enlarged view of a portion of the escutcheon plate assembly shown in FIG. 8;

FIG. 10 is a side perspective view of the escutcheon plate showing a slot formed in an upper portion of the side flange;

FIG. 11 is a front view of the fastening clip shown in FIG. 9;

FIG. 12 is an rear view of the fastening clip shown in FIG. 11;

FIG. 13 is an enlarged perspective view of the fastening clip shown in FIG. 11;

FIG. 14 is a front perspective view of a locking assembly that is used to secure each of the stackable vertical filing cabinets shown in FIG. 1;

FIG. 15 is a rear perspective view of the locking assembly shown in FIG. 14;

FIG. 16 is a cross-sectional view taken along line 16-16 in FIG. 1; and

FIG. 17 is a perspective view of a handle recess insert shown in FIG. 2.

### DETAILED DESCRIPTION OF THE INVENTION

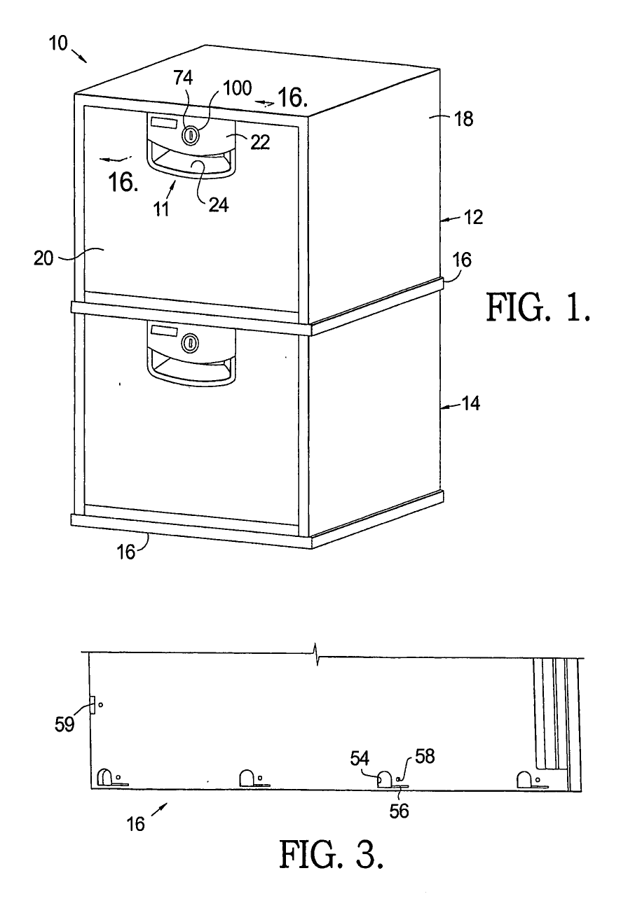

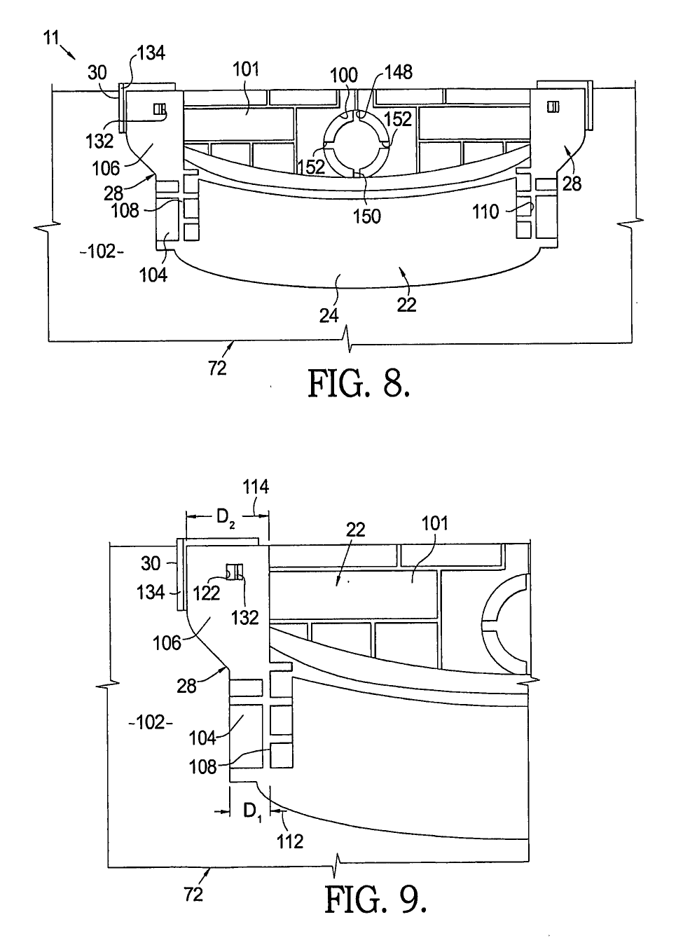

Referring now to the drawings in detail, and initially to FIG. 1, reference numeral 10 generally designates a fire-resistant stackable vertical filing unit including an escutcheon plate assembly 11 constructed in accordance with a first embodiment of the present invention. In general, the filing unit 10 may include an upper fire-resistant filing cabinet or enclosure 12 positioned on top of a lower fire-resistant filing cabinet or enclosure 14. The upper and lower file cabinets 12, 14 each include a base 16, a file housing 18 and a drawer 20. Escutcheon plate assembly 11 includes an escutcheon plate 22 with a handle recess 24 defined therein that may be used in conjunction with a handle recess insert 26 positioned in the opposite side of file housing 18 (FIG. 2) to allow a user to pick-up and move one or more of the filing cabinets 12, 14 to a desired location. Moreover, as best seen in FIG. 8, escutcheon plate 22 includes a pair of side flanges 28 that may be used in conjunction with a pair of fastening clips 30 to securely mount escutcheon plate 22 to drawer 20. It will also be understood and appreciated that filing unit 10 may include a single filing cabinet or more than two filing cabinets stacked on top of one other.

With reference to FIG. 2, file housing 18 includes an external cover shell 32, a rear shell 34, and an internal casing or housing 36, all of which are supported by base 16. External cover shell 32 includes a top section 38 that covers the top portion of internal casing 36, and a pair of side walls 40, 42 that cover the right and left sides of internal casing 36, respectively. Each of the side walls 40, 42 have a plurality of tabs 44 that extend from their lower edge, wherein each of tabs 44 have a mounting hole defined therein. Rear shell 34 is adapted to cover the rear portion of casing 36 and includes a plurality of tabs 46 that extend from its lower edge that may be used to fasten rear wall 34 to base 16. Rear shell 34 may also include an opening 47 so that handle recess insert 26 may be placed therein.

As best seen in FIG. 17, handle recess insert 26 is generally rectangular in shape and has a depression formed therein that is of a depth that allows a user to grip the file cabinet 12, 14, along with handle recess 24, so that cabinet 12, 14 may be picked up and moved to a desired location. In particular, handle recess insert 26 may include a back wall 48, a side wall 50 that extends from the circumferential edge of back wall 48, and an upper edge 52 that is adapted to be secured or rest on the outer surface of rear shell 34 to secure insert 26 to rear shell 34. It will be understood that handle recess insert 26 may be any number of shapes including, but not limited to, oval, square, triangular, circular, or any combination thereof. Moreover, it is also within the scope of the present invention to integrally form handle recess in rear shell 34.

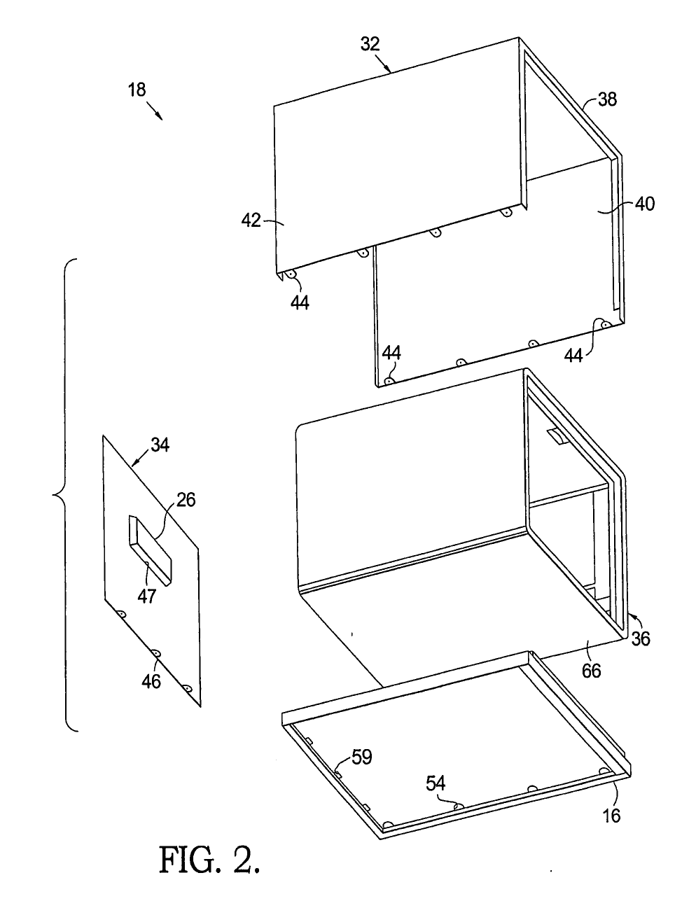

As best seen in FIG. 2, base 16 is positioned beneath internal casing 36 and is adapted to be placed in contact with a support surface. In the alternative, base 16 may also be used to interconnect filing cabinet 12 with a top portion of lower filing cabinet 14 as best seen in FIG. 1. With additional reference to FIG. 3, base 16 also includes a series of slots 54 having a fitted groove 56 that are adapted to receive tabs 44, 46 that extend from side walls 40, 42 and rear shell 34, respectively. A plurality of fastening holes 58 are also formed in base 16. External cover shell 32, rear shell 34 and base 16 may be formed of sheet metal or any other desirable material.

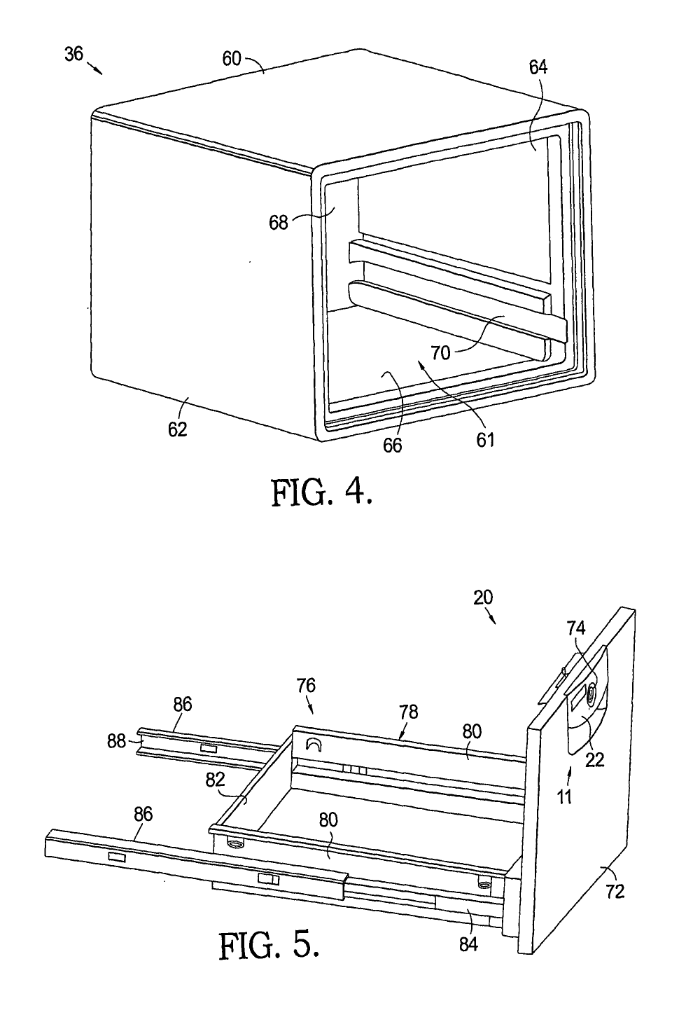

As best seen in FIGS. 2 and 4, internal casing 36 may be blow-molded and filled with a non-flammable, thermal insulating material that solidifies in the mold formed by internal casing 36. In addition, casing 36 includes a front access opening 61, a top wall 60, a pair of side walls 62, 64, a bottom wall 66 and a rear wall 68. A pair of drawer tracks 70 are integrally formed in side walls 62, 64, and are adapted to allow drawer 20 to be slidably attached to casing 36.

In order to assemble the housing 18 shown in FIG. 2, the casing 36 is placed in position on top of base 16. With additional reference to FIG. 3, tabs 44 located on cover shell 32 are then inserted into their corresponding slots 54 in base 16 and slid within fitted groove 56 until each of the holes on tabs 44 are aligned with fastening holes 58. A screw or other type of fastener may then be inserted into the holes to couple base 16 with cover shell 32. Rear shell 34 is mounted to base 16 by inserting tabs 46 into corresponding slots 59 and coupling the rear shell 34 with base 16 using one or more fasteners. With additional reference to FIG. 17, handle recess insert 26 is then mounted within opening 47 formed in rear shell 34. Specifically, the back wall 48 and side wall 50 of handle recess insert 26 are inserted through the opening so that upper edge 52 rests on the outer surface of rear shell 34. The recess insert 26 is slightly larger than the opening formed in the rear shell 34 to provide a secure connection between recess insert 26 and rear shell 34. As stated above, it is also within the scope of the present invention to integrally form recess insert 26 with rear shell 34 or mount the recess insert 26 using an adhesive or mechanical fastener.

As best seen in FIG. 5, the drawer 20 includes a front panel 72, a locking assembly 74, and a track unit 76 that operates to slidably couple drawer 20 with casing 36. Specifically, track unit 76 includes a frame 78 having a pair of opposed side members 80 and a back member 82. The forward edge of each side member 80 is coupled with front panel 72. Further, a pair of drawer tracks 84 are attached to the outer surface of side members 80 on opposite sides of drawer 20 and serve as a guide for a pair of slide members 86. Each slide member 86 may be generally U-shaped and has an inner channel 88 that is adapted to be positioned so that it can slide along the longitudinal axis of drawer track 84. Further, slide members 86 are adapted to be slidably engaged with the drawer tracks 70 (FIG. 4) that are formed in blow-molded casing 36.

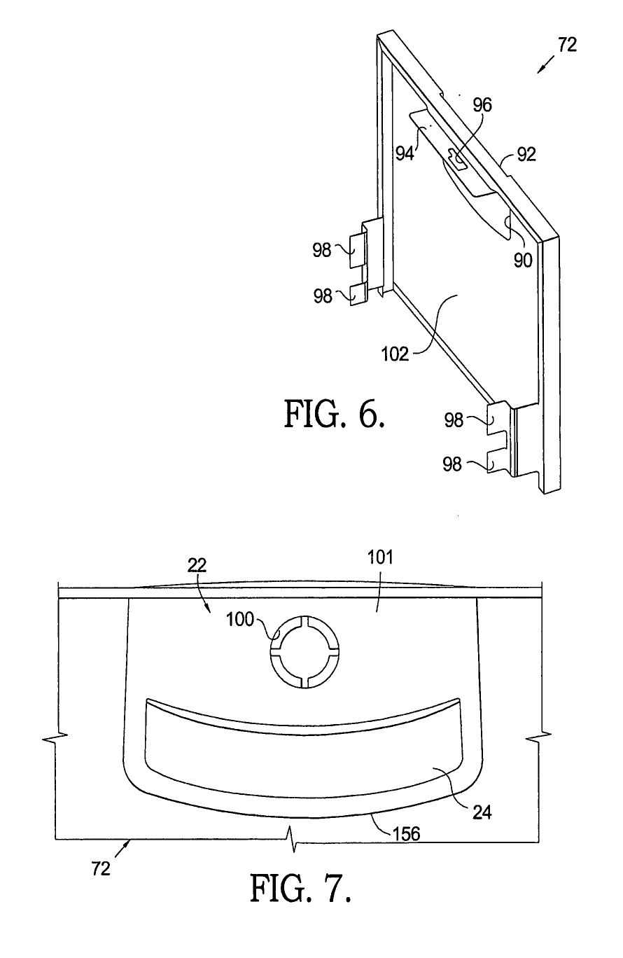

As best seen in FIG. 5, the front panel 72 of the drawer 20 provides a mounting location for escutcheon plate 22 and locking assembly 74. With additional reference to FIG. 6, front panel 72 may have an escutcheon plate opening 90 defined therein, a face plate recess 92, a ledge 94, a latching slot 96, and one or more attaching tabs 98. Attaching tabs 98 may be used to couple front panel 72 with the forward edge of side members 80.

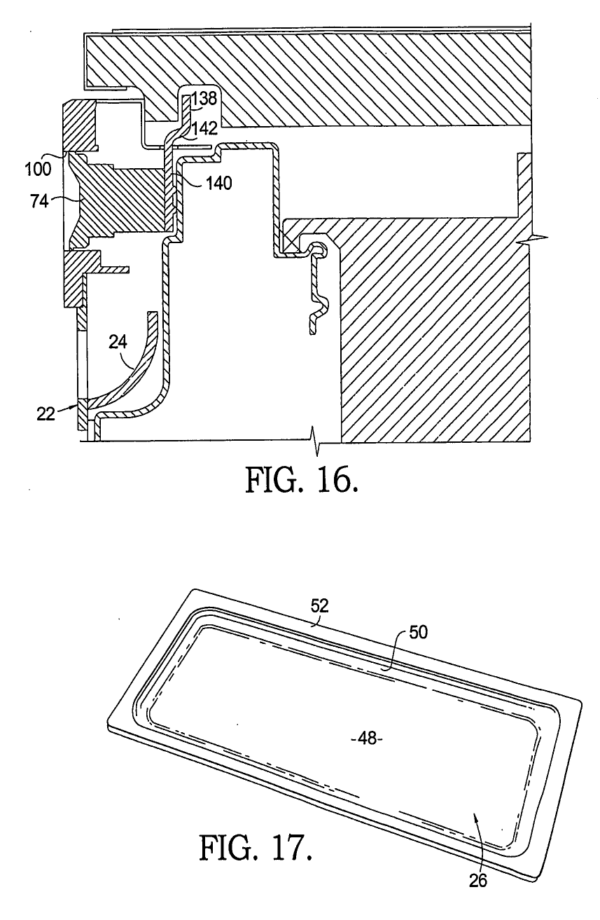

As best seen in FIGS. 7, 8 and 16, escutcheon plate 22 includes an escutcheon plate body 101 that is adapted to be positioned within escutcheon plate opening 90 formed in front panel 72. Escutcheon plate 22 also includes an aperture 100 formed in the escutcheon plate body 101 of the plate 22 which provides a mounting location for locking assembly 74. Further, handle recess 24 may be positioned below aperture 100 and on the opposite side of the filing cabinet from where handle recess insert 26 is located. Handle recess 24 may be sized to allow a user to hold onto escutcheon plate 22 so that filing cabinets 12, 14 may be picked up and moved to a desired location.

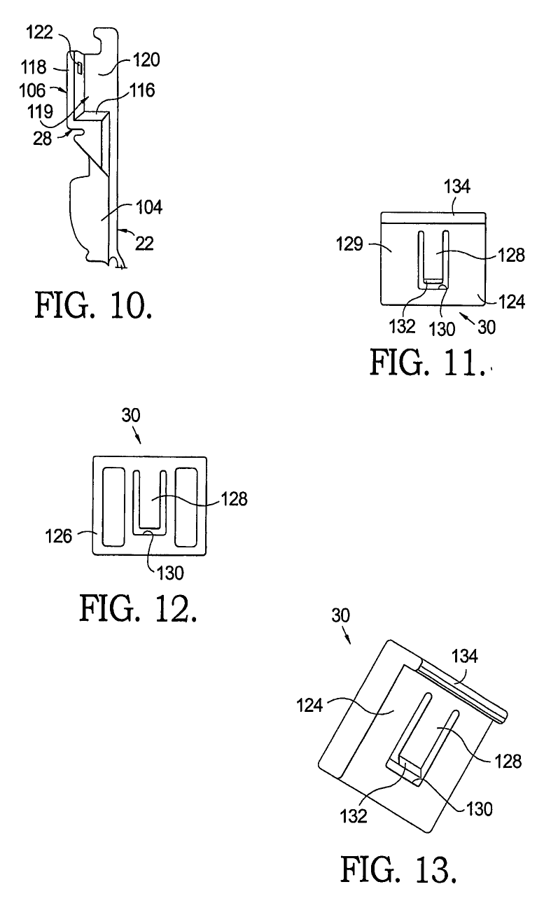

As best seen in FIG. 8, escutcheon plate 22 may also include one or more side flanges 28 that are used with a corresponding number of fastening clips 30 to fasten the escutcheon plate 22 to front panel 72. In particular, each of the fastening clips 30 may be positioned between a back surface 102 of the front panel 72 and the side flange 28 to securely fasten escutcheon plate 22 to front panel 72. It is important to securely fasten escutcheon plate 22 to front panel 72 so that escutcheon plate 22 will not be dislodged or otherwise removed from front panel 72 when a user grabs handle recess 24 in the escutcheon plate 22 to move or pick up the file cabinet 12, 14. In accordance with the present invention, side flange 28 extends outwardly from body 101 and includes a lower portion 104 and an upper portion 106, wherein lower and upper portions 104, 106 extend outwardly from a pair of side edges 108, 110 of escutcheon plate 22 so that portions 104, 106 are generally parallel to back surface 102 of front panel 72. Therefore, lower and upper portions 104, 106 generally overlap with the front panel 72, but do, not necessarily contact back surface 102 along the entire portion of lower and upper portions 104, 106. With specific reference to FIG. 10, a slot 119 may be defined in at least one of lower and upper portions 104, 106, wherein slot 119 extends away from back surface 102 of front panel 72. As best seen in FIGS. 8 and 9, lower portion 104 extends outwardly from escutcheon plate body 101 at a first distance 112 (D₁) from side edges 108, 110, and upper portion 106 extends outwardly from escutcheon plate body 101 at a second distance 114 (D₂) from side edges 108, 110 of escutcheon plate 22. Second distance 114 is greater than first distance 112 in order to increase the amount of surface contact area between side flange 28, fastening clip 30, and back surface 102 of front panel 72, which firmly secures escutcheon plate 22 to front panel 72 when a user picks up or moves filing cabinet 12, 14. In particular, upper portion 106 may extend approximately twice the distance from the side edges 108, 110 of escutcheon plate 22 compared to lower portion 104. However, it will be understood and appreciated that the first distance D₁ may be larger than the second distance D₂.

As best seen in FIG. 10, upper portion 106 may also include an extension wall 116 and an offset wall 118 that define slot 119 for receiving fastening clip 30 (FIG. 11). Extension wall 116 may extend from upper portion 106 at a perpendicular angle relative to upper portion 106 and back surface 102 of front panel 72. Further, offset wall 118 may extend from extension wall 116 so that offset wall 118 is generally parallel with upper portion 106 and back surface 102 of front panel 72. Extension wall 116 is used to position offset wall 118 away from back surface 102 of front panel 72 at a distance slightly greater than the thickness of fastening clip 30 so that fastening clip 30 may slide between upper portion 106 and back surface 102 of front panel 72 and be securely positioned therebetween. Fastening clip 30 may be slid into slot 119 defined by extension wall 116 and offset wall 118 until fastening clip 30 comes into contact with, or is adjacent to, a side wall 120 of escutcheon plate 22. However, fastening clip 30 and side wall 120 do not necessarily have to come into contact to secure escutcheon plate 22 to front panel 72. Furthermore, a snap opening 122 may be defined in extension wall 116 to allow fastening clip 30 to be securely positioned within slot 119.

As best seen in FIGS. 11-13, fastening clip 30 includes front and rear surfaces 124, 126 and is adapted to fit into slot 119 formed in upper portion 106 of side flange 28. Fastening clip 30 includes a snap arm 128 that extends from a main body 129 of fastening clip 30 and within an opening 130 defined in fastening clip 30. Snap arm 128 is capable of flexing about a connecting point where snap arm 128 joins main body 129 of fastening clip 30. With specific reference to FIGS. 9 and 13, snap arm 120 may include a protrusion 132 that extends from the distal end of snap arm 128 that may be releasably inserted within snap opening 122. Protrusion 132 operates to releasably secure fastening clip 30 within slot 119.

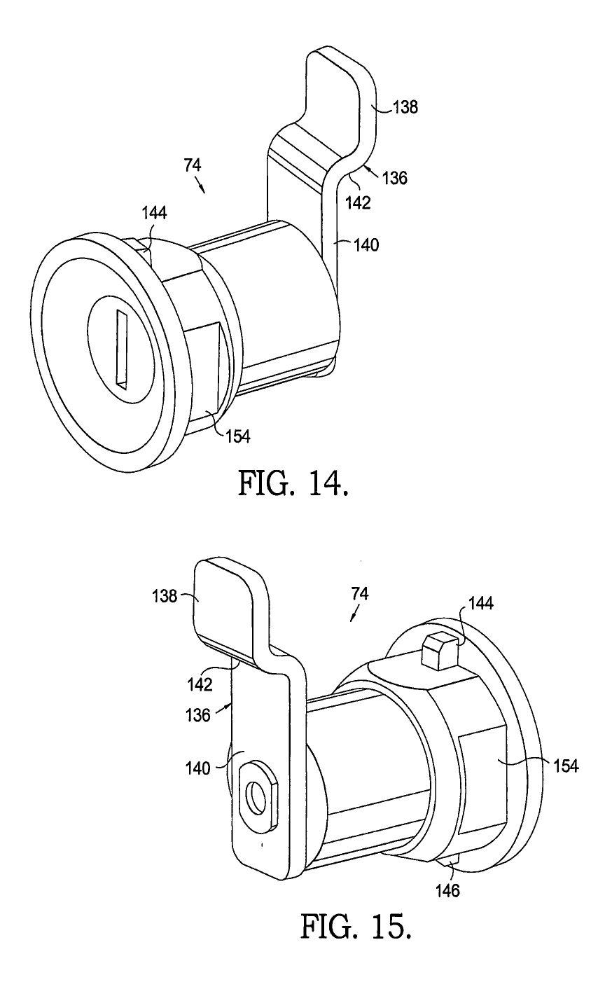

As best seen in FIG. 1, locking assembly 74 may be mounted within opening 100 defined in escutcheon plate 22 to allow a user to selectively lock and unlock filing cabinet 10. As best seen in FIGS. 14-16, lock assembly 74 may be formed of a die cast material, and a cam 136 that makes up a portion of lock assembly 74 may be formed of steel. Cam 136 may also include a locking leg 138, an attaching leg 140 and a flat portion 142. Additionally, the attaching leg 140 has a slot (not shown) for allowing the cam 136 to be attached to the internal bezel (not shown) by a fastener.

Lock assembly 74 may be inserted through the front of escutcheon plate 22 and securely fastened within opening 100. Specifically, as best seen in FIGS. 8, 14 and 15, an upper tab 144 and a lower tab 146 of the lock assembly 74 are aligned with an upper slot 148 and a lower slot 150 on the escutcheon plate 22 to assure proper positioning in escutcheon plate 22. Once lock assembly 74 is properly aligned, a pair of side tabs 152 on escutcheon plate 22 are snapped within a pair of side recesses 154, thereby securing locking assembly 74 to escutcheon plate 22. While securing locking assembly 74 to escutcheon plate 22, the locking leg 138, attaching leg 140 and a flat portion 142 are inserted in the latching slot 96 shown in FIG. 6.

In order to attach escutcheon plate 22 to front panel 72 of drawer 20, the top edge of escutcheon plate 22 is inserted through face plate recess 92 formed in escutcheon plate opening 90 from the back side of front panel 72. The lower and upper portions 104, 106 of side flanges 28 are then placed adjacent to back surface 102 of front panel 72 as best seen in FIG. 9, and a lower edge 156 of escutcheon plate 22 is in contact with the front surface of front panel 72 as best seen in FIG. 7. Fastening clips 30 may then be inserted into slots 119 so that rear surface 126 of fastening clip 30 is in contact with back surface 102 of drawer 20, upper portion 106 of side flange 28 is in contact with front surface 124 of fastening clip 30, lower portion 104 is adjacent to back surface 102 of drawer 20, and lower edge 156 of escutcheon plate 22 is adjacent to the front surface of front panel 72. As fastening clips 30 are inserted into each slot 119, snap arm 128 bends slightly as protrusion 132 slides along the inside surface of offset wall 118. Snap arm 128 then operates to snap protrusion 132 within opening 122, which in turn holds clip 30 in position within slot 119. Therefore, the fastening clip 30 fits between escutcheon plate 22 and back surface 102 of drawer 20 and acts as a positive stop to securely hold escutcheon plate 22 in position on the drawer 20. If there is some variability in the fit between escutcheon plate 22 and front panel 72, escutcheon plate 22 may still be securely held in position on the drawer 20 using escutcheon plate assembly 11. To remove fastening clip 30 from slot 119, a downward force is applied to protrusion 132 so that fastening clip 30 may be slid out of slot 119. Also, as best seen in FIG. 13, a ridge 134 formed along the top edge of clip 30 may be used to assist in sliding fastening clip 30 out of slot 119.

In sum, the present invention includes an escutcheon plate having a pair of side flanges, wherein each of the flanges have at least one extended upper portion that is secured to the front panel of the filing cabinet using a fastening clip. The extended upper portion of the side flanges provides increased contact surface area between the escutcheon plate and front panel, which in turn increases the distribution of force imposed on each of the side flanges when the escutcheon plate is used to pick up or otherwise move the enclosure. As such, the escutcheon plate assembly securely attaches the escutcheon plate to the front panel of the drawer. Furthermore, the present invention is also directed to the combination of the handle recess formed in the escutcheon plate and the handle recess positioned in the rear shell. By positioning a pair of handles on opposite sides of the filing cabinet, it provides two locations for a user to pick up and move the filing cabinet to a desired location without having to push the filing cabinet along the ground or trying to lift the filing cabinet using a single handle.

While particular embodiments of the invention have been shown, it will be understood, of course, that the invention is not limited thereto, since modifications may be made by those skilled in the art, particularly in light of the foregoing teachings. Reasonable variation and modification are possible within the scope of the foregoing disclosure of the invention without departing from the spirit of the invention.

What is claimed is:

1. An escutcheon plate assembly for a fire-resistant enclosure, the enclosure having a drawer with a front panel, wherein the front panel has an opening defined therein, the escutcheon plate assembly comprising:
an escutcheon plate body adapted to be positioned within the opening in the front panel;
at least one flange extending outwardly from the escutcheon plate body; and
a fastening clip that is adapted to be positioned between the front panel and the at least one flange.

2. The escutcheon plate assembly in claim 1, wherein the at least one flange includes first and second portions, wherein the first portion extends outwardly at a first distance from the escutcheon plate body, and wherein the second portion extends outwardly at a second distance from the escutcheon plate body.

3. The escutcheon plate assembly in claim 2, wherein the first distance is greater than the second distance.

4. The escutcheon plate assembly in claim 3, wherein the first distance is approximately two times greater than the second distance.

5. The escutcheon plate assembly in claim 3, wherein a slot is defined in the first portion of the at least one flange.

6. The escutcheon plate assembly in claim 1, wherein the fastening clip has an opening defined therein, wherein a snap arm extends from a main body of the fastening clip and is positioned within the opening, and wherein the snap arm has a protrusion extending therefrom that fits within a snap opening defined in the at least one flange.

7. The escutcheon plate assembly in claim 6, wherein the fastening clip further includes a ridge formed along an edge of the fastening clip.

8. The escutcheon plate assembly in claim 1, wherein the escutcheon plate body has a handle recess defined therein.

9. The escutcheon plate assembly in claim 1, further comprising a locking assembly coupled with the escutcheon plate body.

10. The escutcheon plate assembly in claim 1, wherein the escutcheon plate body includes a side edge, and wherein the at least one flange extends from the side edge.

11. The escutcheon plate assembly in claim 1, wherein the at least one flange and the front panel overlap.

12. The escutcheon plate assembly in claim 11, wherein at least a portion of the at least one flange is positioned adjacent to a back surface of the front panel.

13. The escutcheon plate assembly in claim 1, wherein the at least one flange includes an extension wall and an offset wall, wherein the extension wall and the offset wall define a slot, and wherein the slot is adapted to receive the fastening clip.

14. The escutcheon plate assembly in claim 13, wherein the extension wall extends in a generally perpendicular direction away from a back surface of the front panel, and wherein the offset wall extends from the extension wall in a direction that is generally parallel to the back surface of the front panel.

15. The escutcheon plate assembly in claim 13, wherein the fastening clip has an opening defined therein, wherein a snap arm extends from a main body of the fastening clip and is positioned within the opening defined in the fastening clip, and wherein the snap arm has a protrusion extending therefrom that fits within a snap opening defined in the offset wall.

16. An escutcheon plate assembly for a fire-resistant enclosure, the enclosure having a drawer with a front panel, wherein the front panel has an opening defined therein, the escutcheon plate assembly comprising:
an escutcheon plate body adapted to be positioned within the opening in the front panel;
at least one flange including first and second portions, the first portion extending outwardly at a first distance from the escutcheon plate body, the second portion extending outwardly at a second distance from the escutcheon plate body, the first distance being greater than the second distance, the first portion including an extension wall and an offset wall that define a slot; and
a fastening clip that is adapted to be positioned within the slot between the front panel and the first portion of the at least one flange.

17. The escutcheon plate assembly in claim 16, wherein the first distance is approximately two times greater than the second distance.

18. The escutcheon plate assembly in claim 16, wherein the fastening clip further includes a ridge formed along an edge of the fastening clip.

19. The escutcheon plate assembly in claim 16, wherein the escutcheon plate body has a handle recess defined therein.

20. The escutcheon plate assembly in claim 16, further comprising a locking assembly coupled with the escutcheon plate body.

21. The escutcheon plate assembly in claim 16, wherein the at least one flange and the front panel overlap.

22. The escutcheon plate assembly in claim 16, wherein the extension wall extends in a generally perpendicular direction away from a back surface of the front panel, and wherein the offset wall extends from the extension wall in a direction that is generally parallel to the back surface of the front panel.

23. The escutcheon plate assembly in claim 16, wherein the fastening clip has an opening defined therein, wherein a snap arm extends from a main body of the fastening clip and is positioned within the opening defined in the fastening clip, and wherein the snap arm has a protrusion extending therefrom that fits within a snap opening defined in the offset wall.

24. A fire-resistant enclosure comprising:
an internal housing including a front access opening and a rear wall;
a front panel for covering the front access opening of the internal housing, the front panel having an opening defined therein;
an escutcheon plate assembly positioned within the opening in the front panel, the escutcheon plate assembly having a body with a handle recess defined therein; and
a rear shell covering at least a portion of the rear wall of the internal housing, wherein the rear shell is positioned opposite of the front panel, and wherein the rear shell includes a handle recess insert.

25. The fire-resistant enclosure in claim 24, wherein the handle recess insert is integrally formed in the rear shell.

26. The fire-resistant enclosure in claim 24, wherein the escutcheon plate assembly further comprises:
at least one flange extending from the body, wherein the flange has a slot defined therein; and
a fastening clip that is adapted to be positioned within the slot.

27. The fire-resistant enclosure as recited in claim 26, wherein the at least one flange includes first and second portions, wherein the first portion extends from the body at a first distance, and wherein the second portion extends from the body at a second distance.

28. The fire-resistant enclosure in claim 27, wherein the first distance is greater than the second distance.

29. The fire-resistant enclosure in claim 28, wherein the slot is formed in the first portion of the flange.
